(19) United States
(12) Patent Application Publication
(10) Pub. No.: US 2018/0336326 A1
(43) Pub. Date: Nov. 22, 2018

(54) SYSTEM FOR ELECTRONIC AUTHENTICATION WITH BOT DETECTION AND DENIAL

(71) Applicant: BANK OF AMERICA CORPORATION, Charlotte, NC (US)

(72) Inventors: Matthew Joseph Wallace, Media, PA (US); Kerry Michelle Cantley, Fort Mill, SC (US); Greg M. Correro, Oak Point, TX (US); Michael Lee Funk, Hockessin, DE (US); Jeantou Alphonse DeGrammont, Decatur, GA (US); Glenn Edward Hupfer, Highland Village, TX (US); Murali Sampath, Flower Mound, TX (US); Donna Lynne Shannon, Mesa, AZ (US)

(21) Appl. No.: 15/597,481

(22) Filed: May 17, 2017

(51) Int. Cl. G06F 21/31; H04L 29/06

(52) U.S. Cl. CPC G06F 21/316; H04L 2463/144; G06F 2221/2133; H04L 63/08

(57) ABSTRACT

Systems, computer products, and methods are described herein for electronic authentication with bot detection and denial. In this way, the system utilizes user device information to discern an authorization or authentication is being requested by a human as part of either an authentication process or authorization process. As such, the system identifies that the user is a human and not a bot or other device attempting to gain authorization. In some embodiments, the system links to a user device and in one or more embodiments reviews live video in the form of a real-time video stream, requires human movement of a user device, identifies device irregularities, and/or device networking interactions to prove the request for authorization is a human request.

### BACKGROUND

Authenticating a user is increasingly difficult especially in view of the fact that interactions between users and/or entities are more frequently occurring apart from one another over the Internet and less frequently face-to-face. Moreover, due to the increase in the frequency of electronic interactions between users and/or entities all types of interactions (e.g., over the Internet and/or face-to-face) are subject to potential security issues. As such, improved authentication systems are needed to provide more accurate authentication of users.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In some embodiments, the system accesses and utilizes information regarding the user or device to discern that a transaction or resource distribution is being performed by a user as part of either an authentication process or authorization process. As such, the system identifies that the user is a human and not a bot or other device and approves the transaction based on indication of the user being human. In some embodiments, the system may use live video in the form of a real-time video stream to prove the user liveness as part of authentication or authorization of a transaction. In other embodiments, the system links to the user's mobile device and requires the user to move his/her device in a specific motion to prove liveness as part of authentication or authorization of a transaction. Furthermore, through the linkage the system may monitor the user's mobile device irregularities such as if the device is moving at a high rate of speed, the device has not moved for an extended period of time, the use or activity of the device prior to the authentication request, or the like. In some embodiments, the system accesses the user's social media accounts to determine that the authorization request is from a human and not a bot.

Embodiments of the invention relate to systems, methods, and computer program products for bot detection and denial during electronic authentication, the invention comprises: receiving a request from a user application to provide bot detection for electronic authentications; accessing a user device associated with the user application and link, via a communicable linkage into the user device; identifying the user device movements and store the movements as regular movements associated with the user device; triggering one or more bot detection identifiers upon indication of authorization request processing, wherein the one or more bot detection identifiers includes requiring at least a verified liveness of a user associated with the authorization request processing; extracting and retrieving the verified liveness from the user application via the communicable linkage; determining liveness of generation of the authorization request processing based on a non-irregularity determination of the one or more bot detection identifiers; and authorizing authentication request as human and not bot generated.

In some embodiments, one or more bot detection identifiers comprises a device movement bot detection identifier, wherein the device movement bot detection further comprises requesting the user to move the user device in a specific pattern or during a time period for confirmation of liveness.

In some embodiments, one or more bot detection identifiers comprises a device motion irregularity bot detection identifier, wherein the device motion irregularity bot detection identifier further comprises comparing the regular movements associated with the user device with movements at the time of the authorization request and a period of time before the authorization request to identify a regularity in the movements associated with the user device for confirmation of liveness.

In some embodiments, one or more bot detection identifiers comprises a network interaction bot detection identifier, wherein the network interaction bot detection identifier further comprises identifying a name associated with the authorization request and comparing the name to network interactions under that name for confirmation of liveness.

In some embodiments, one or more bot detection identifiers comprises a real-time video stream bot detection identifier, wherein the real-time video stream bot detection identifier further comprises requesting the user to generate a real-time video stream of the user or user surroundings for confirmation of liveness.

In some embodiments, the invention further comprises denying the authorization request based on irregularities determined from one or more of the one or more bot detection identifiers.

In some embodiments, liveness further comprises human activity or human generation of the authorization request processing, wherein liveness is not a generation of authorization request processing by software.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, and wherein:

FIG. 1 illustrates a bot detection and denial authentication system environment, in accordance with embodiments of the present invention;

FIG. 2 is a flowchart illustrating a high level view of bot detection and denial for electronic authorization, in accordance with embodiments of the present invention;

FIG. 3 is a flowchart illustrating the setup process for the bot detection and denial system, in accordance with embodiments of the present invention;

FIG. 4 is a process flowchart illustrating a high level process of using the bot detection and denial system, in accordance with embodiments of the present invention;

FIG. 5 is a flowchart illustrating one embodiment of the bot detection and denial system, in accordance with embodiments of the present invention;

FIG. 6 is a flowchart illustrating one embodiment of the bot detection and denial system, in accordance with embodiments of the present invention; and

FIG. 7 is a flowchart illustrating one embodiment of the bot detection and denial system, in accordance with embodiments of the present invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

In some embodiments, the system accesses and utilizes information regarding the user or device to discern that a transaction or resource distribution is being performed by a user as part of either an authentication process or authorization process. As such, the system identifies that the user is a human and not a bot or other device and approves the transaction based on indication of the user being human. In some embodiments, the system may use live video in the form of a real-time video stream to prove the user liveness as part of authentication or authorization of a transaction. In other embodiments, the system links to the user's mobile device and requires the user to move his/her device in a specific motion to prove liveness as part of authentication or authorization of a transaction. Furthermore, through the linkage the system may monitor the user's mobile device irregularities such as if the device is moving at a high rate of speed, the device has not moved for an extended period of time, the use or activity of the device prior to the authentication request, or the like. In some embodiments, the system accesses the user's social media accounts to determine that the authorization request is from a human and not a bot.

A “transaction” or “resource distribution” refers to any communication between a user and the financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In some embodiments, an “entity” may be a financial institution or third party merchant. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself. In some embodiments, the “user” may be a customer (e.g., an account holder).

In some embodiments, liveness identification may include one or more identifiers that identify a human as being the instigator of an authentication or authorization request. In this way, the authentication or authorization may require a liveness indication that provides a level of confidence to the system that a human is initiating a transaction and not an electronic bot or malicious software. An internet bot, or bot, as used herein is a software application that may run one or more automated scripts over a network at a high rate.

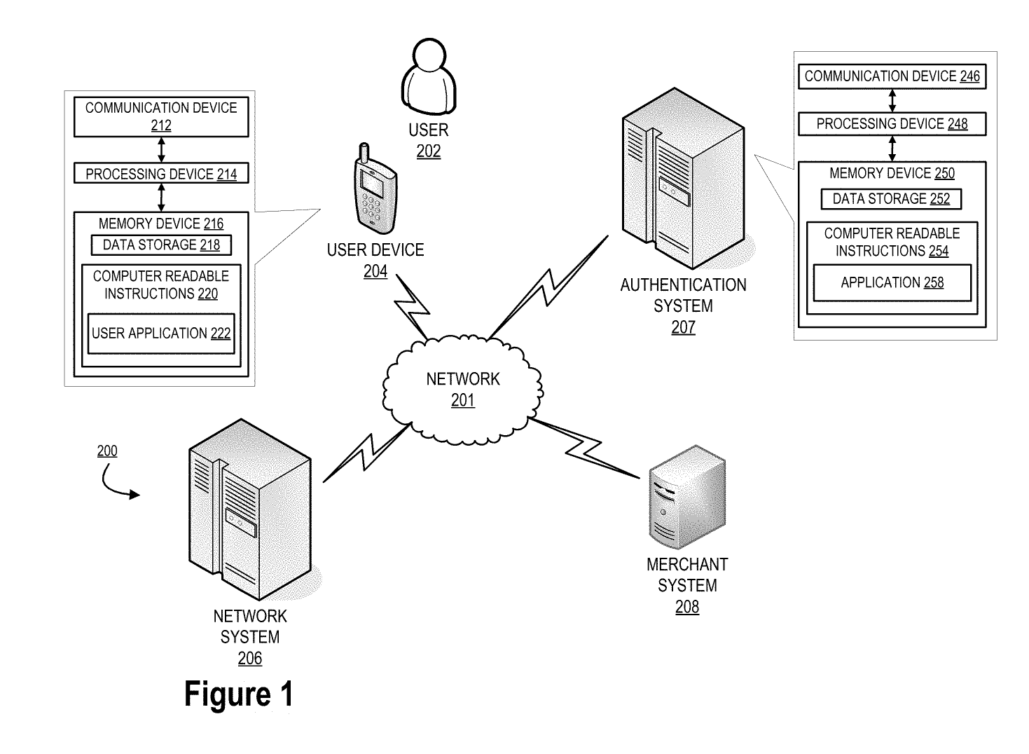

FIG. 1 illustrates a bot detection and denial authentication system environment 200, in accordance with embodiments of the present invention. FIG. 1 provides the system environment 200 for which the distributive network system with specialized data feeds associated with resource distribution. FIG. 1 provides a unique system that includes specialized servers and system communicably linked across a distributive network of nodes required to perform the functions of physical maker coding for resource distribution adjustment and authentication.

As illustrated in FIG. 1, the merchant system 208 is operatively coupled, via a network 201 to the user device 204, authentication system 207, and to the network system 206. In this way, the merchant system 208 can send information to and receive information from the user device 204, authentication system 207, and the network system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual that desires to be authenticated into an application, transaction, resource distribution, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the network system 206, the merchant system 208, and the authentication system 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 is utilized and in communication with the authentication system 207 for authentication based on bot detection and denial.

As further illustrated in FIG. 1, the authentication system 207 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the merchant system 208, the network system 206, and the user device 204. As such, the communication device 246 generally comprises a modem, server, or other device for communicating with other devices on the network 201.

As further illustrated in FIG. 1, the authentication system 207 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the authentication system 207 the memory device 250 stores an application 258. Furthermore, the authentication system 207, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more merchant system 208, authentication system 207, and/or user device 204.

As illustrated in FIG. 1, the network system 206 is connected to the merchant system 208, user device 204, and authentication system 207. The network system 206 has the same or similar components as described above with respect to the user device 204 and the authentication system 207. The network system 206 may be connected to the merchant system 208, the authentication system 207, and the user device 204 via the network 201. The network system 206 may approve a resource distribution based on an authentication and communicate the approval for resource distribution.

As illustrated in FIG. 1, the merchant system 208 is connected to the authentication system 207, user device 204, and network system 206. In other embodiments, the merchant system 208 may be a third party system separate from the network system 206. The merchant system 208 has the same or similar components as described above with respect to the user device 204 and the network system 206. While only one merchant system 208 is illustrated in FIG. 1, it is understood that multiple merchant system 208 may make up the system environment 200.

It is understood that the servers, systems, and devices described herein illustrate one embodiment of the invention. It is further understood that one or more of the servers, systems, and devices can be combined in other embodiments and still function in the same or similar way as the embodiments described herein. The merchant system 208 and network system 206 may generally include a processing device communicably coupled to devices as a memory device, output devices, input devices, a network interface, a power source, one or more chips, and the like. The merchant system 208 and network system 206 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the merchant system 208 and network system 206 described herein.

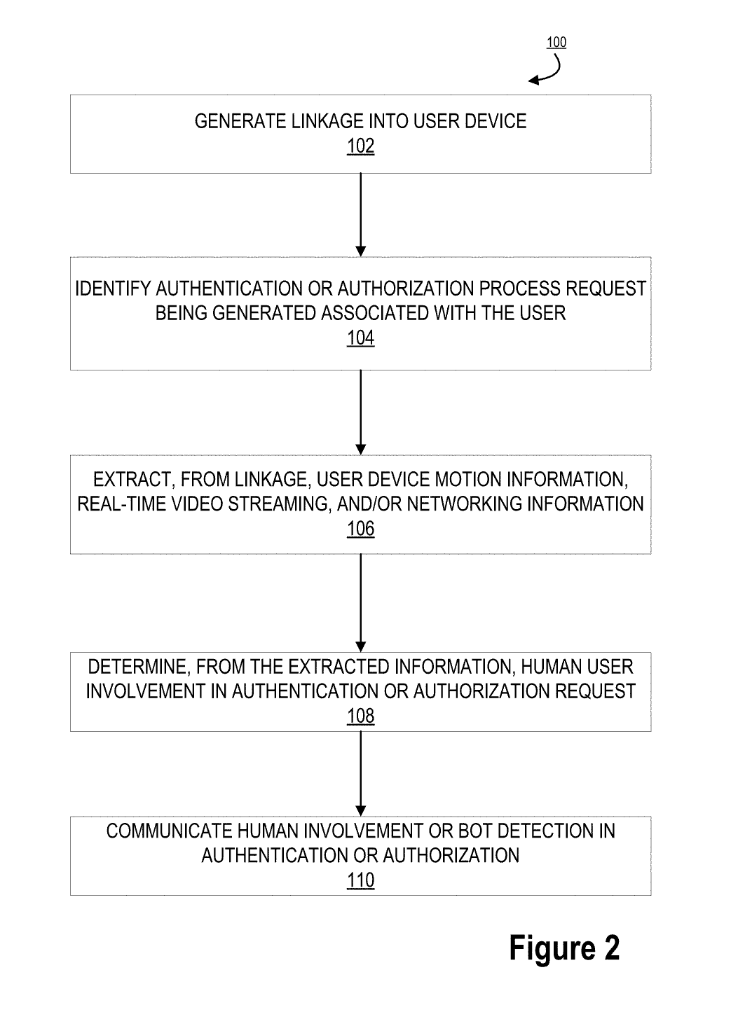

FIG. 2 illustrates a high level view of bot detection and denial for electronic authorization 100, in accordance with embodiments of the present invention. As illustrated in block 102, the process 100 is initiated by generating a linkage into a user device. In this way, the authentication system may link into the user device in order to provide bot detection. As such, the system may review real-time video stream, identify irregularities in motion, or the like.

As illustrated in block 104, the process 100 continues by identifying the authentication or authorization process request being generated that are associated with the user. In this way, the system identifies that there is an authentication or authorization process requested. The request may be from a network system, merchant system, third party system, from the user, or from a bot.

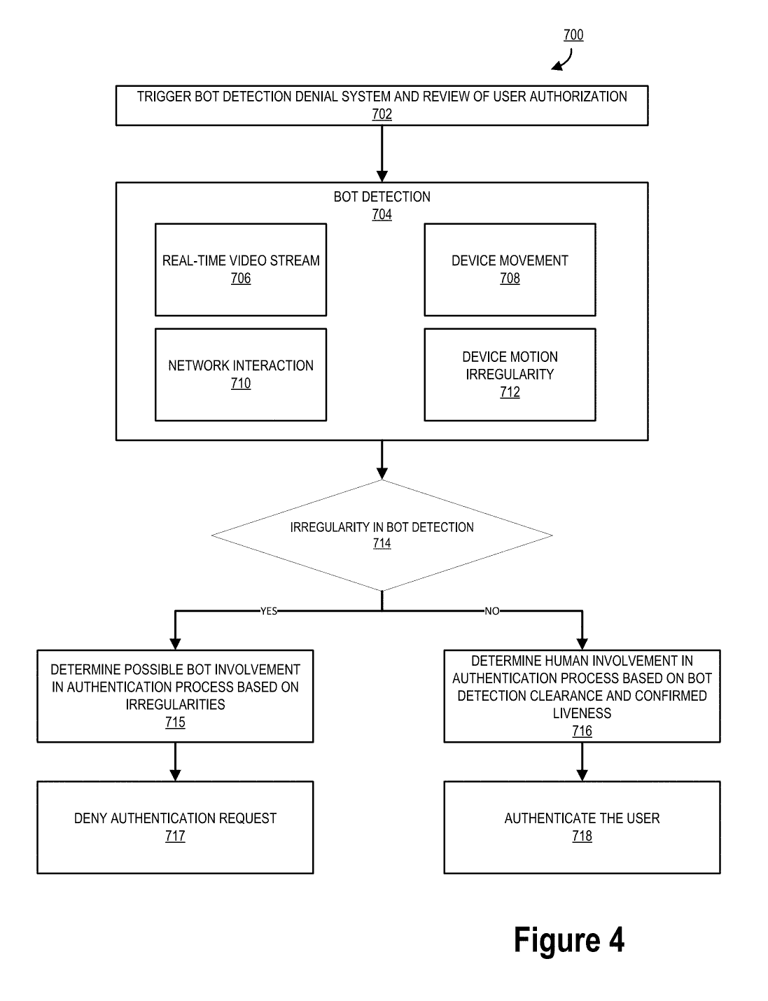

Next, upon indication of an authentication or authorization process being requested, the system may extract or otherwise view via the linkage, user device motion information, real-time video streaming, and/or network information. The process of extracting and utilizing this information is further described below with respect to FIGS. 4-7. From the extracted information, the system may, as illustrated in block 108, determine human user involvement in the authentication or authorization request. As such, the system may determine if a human was involved in the request or if a bot was detected as being associated with the authentication or authorization.

Finally, as illustrated in block 110, the process 100 is completed by communicating either human involvement or bot detection within the authentication or authorization request processing.

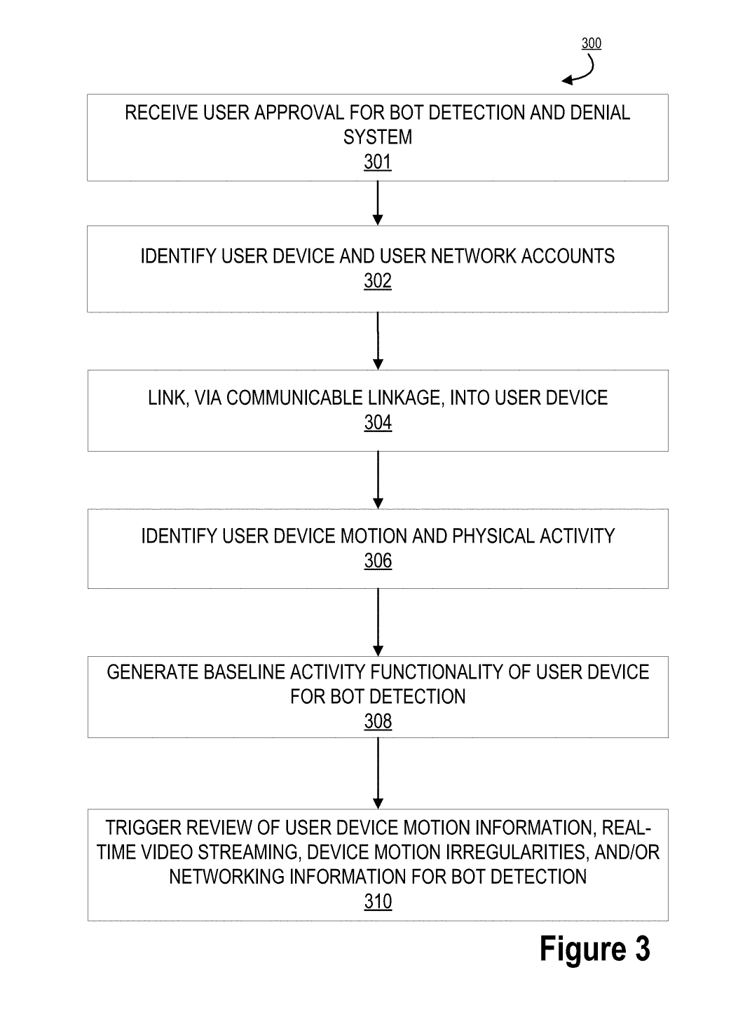

FIG. 3 illustrates the setup process for the bot detection and denial system 300, in accordance with embodiments of the present invention. As illustrated in block 301, the process 300 is initiated by receiving user approval for integration of the bot detection and denial system. As such, the user may allow the system for integration within the user device for bot detection and user device monitoring. Once the user has approved the bot detection and denial system integration, the system may identify one or more user devices and user network accounts, as illustrated in block 302. In this way, the system identifies the devices associated with the user and user network accounts, such as accounts with one or more third parties, resource distribution accounts, or the like.

Next, as illustrated in block 304, the process 300 continues by linking, via a communicable linkage, the system in association with the user device. This linkage allows the system to securely communicate with and distribute data with the user device. Once the linkage has been generated, the system may continue the set up by identifying motion of the user device and the physical activity associated therewith, as illustrated in block 306. In this way, the system may learn the regular physical motions of the device, such as the speed the device moves, directions the device moves, times the device is still, times the device is moving, and the like. In some embodiments, the system may learn the regularities of the user device with respect to physical movement. Next, as illustrated in block 308, based on the identified user device motion and physical activity, the system may generate a baseline activity functionality of the user device for future bot detection.

Finally, as illustrated in block 310, the process 300 is completed by triggering a review of user device motion information, real-time video streaming, device motion irregularities, and/or network information for bot detection.

In some embodiments, the system accesses and utilizes information regarding the user or device to discern that a transaction or resource distribution is being performed by a user as part of either an authentication process or authorization process. As such, the system identifies that the user is a human and not a bot or other device and approves the transaction based on indication of the user being human. In some embodiments, the system may use live video in the form of a real-time video stream to prove the user liveness as part of authentication or authorization of a transaction. In other embodiments, the system links to the user's mobile device and requires the user to move his/her device in a specific motion to prove liveness as part of authentication or authorization of a transaction. Furthermore, through the linkage the system may monitor the user's mobile device irregularities such as if the device is moving at a high rate of speed, the device has not moved for an extended period of time, the use or activity of the device prior to the authentication request, or the like. In some embodiments, the system accesses the user's social media accounts to determine that the authorization request is from a human and not a bot.

FIG. 4 illustrates a process flowchart of high level process of using the bot detection and denial system 700, in accordance with embodiments of the present invention. As illustrated in block 702, the process 700 is initiated by triggering the bot detection denial system. In this way, the system initiates the review of the user's authorization. As illustrated in block 704, the bot detections include real-time video stream 706, device movement 708, network interaction 710, and device motion irregularity 712.

In some embodiments, the bot detection may include real-time video stream 706. In this way, the system may request a real-time video stream from the user device. In some embodiments, the system may automatically activate the user device to deploy the real-time video stream from the user device. In other embodiments, the system may request the user to provide a real-time video stream of the user and/or the user surroundings. As such, the system may be able to determine human activity and not bot requesting the authentication.

In some embodiments, the bot detection may include device movement 708. In this way, the system may request the user move the user device in a specific pattern or movement to determine that a human requested the authentication and not a bot.

In some embodiments, the bot detection may include network interaction 710. In this way, the system may identify user network interaction to determine if a human is involved in the authentication transaction. As such, the system may monitor network interaction to determine if the user requesting the authentication has a network presences and is a human and not a bot.

In some embodiments, the bot detection may include device motion irregularity 712. In this way, the system may identify irregularities associated with user device motion or activity. The irregularity, such as moving very fast, not moving for an extended period of time, or the like may indicate to the system an irregularity and potential bot detection

Using the bot detection 704, the system may determine, in decision block 714, if an irregularity was identified in the bot detection. In some embodiments, the system may determine that there was no bot detection due to any irregularity. In that instance, as illustrated in block 716, the process 700 continues by determining human involvement in the authentication process based on the bot detection clearance and confirmation of liveness associated with the authentication. Next, as illustrated in block 718, the system allows the authentication of the user and completion of the transaction.

In some embodiments, the bot detection system identifies an irregularity in decision block 714. In that instance, as illustrated in block 715, the process 700 continues by determining a possible bot involvement in an authentication process based on the identified irregularities. Next, upon identification of the irregularities, the system may deny the authentication request, as illustrated in block 717.

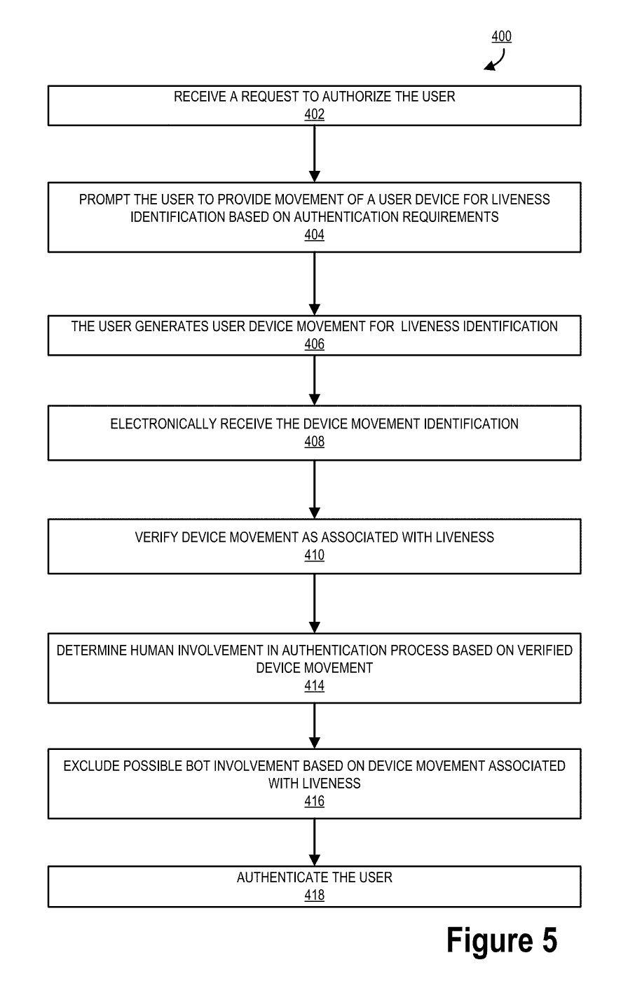

FIG. 5 illustrates a process of one embodiment of the bot detection and denial system 400, in accordance with embodiments of the present invention. As illustrated in block 402, the process 400 is initiated by receiving a request to authorize the user. In some embodiments, this authorization or authentication is an electronic authorization or authentication. In some embodiments, it may be generated from a device associated with a user. In other embodiments, it may be generated from a bot or via misappropriated application.

As illustrated in block 404, the process 400 continues by prompting the user to provide movement or a user device for liveness identification based on the authentication requirements. As such, the system may be triggered to perform bot detection based on a request for authorization. In this way, the system requires the user to pick up the user device, such as a mobile device or mobile phone and motion with the device. In some embodiments, the system requires the user to motion the device in a specific pattern. In some embodiments, the system requires the user to motion the device during a specific time period.

As illustrated in block 406, the process 400 continues by the user generating the user device movement for liveness identification. In some embodiments, the user may motion the device in a specific pattern. In some embodiments, the user may motion the device during a specific time period.

Upon motioning of the device, the system may electronically receive the device movement identification, as illustrated in block 408. This electronic receiving may be generated via the linkage and integration of the system within the user device. As such, as the user is motioning or moving the device, the system monitors and receives those motions in real-time. Once the movements have been identified and electronically transmitted, the system may verify the device movement as being associated with liveness or human movement of the device, as illustrated in block 410. In this way, based on the specific motion or movement the system may identify one or more motions that are specifically human in nature and not that of a bot.

As illustrated in block 412, the process 400 continues by determining human involvement in the authentication process based on the verified device movement, as illustrated in block 414. Once the system has verified the human involvement in the movement and the authentication. Based on the verification, the system excludes possible bot involvement based on the device movement associated with the liveness, as illustrated in block 416. Finally, as illustrated in block 418, the process 400 is finalized by allowing for authentication of the user for the electronic authentication or authorization requested.

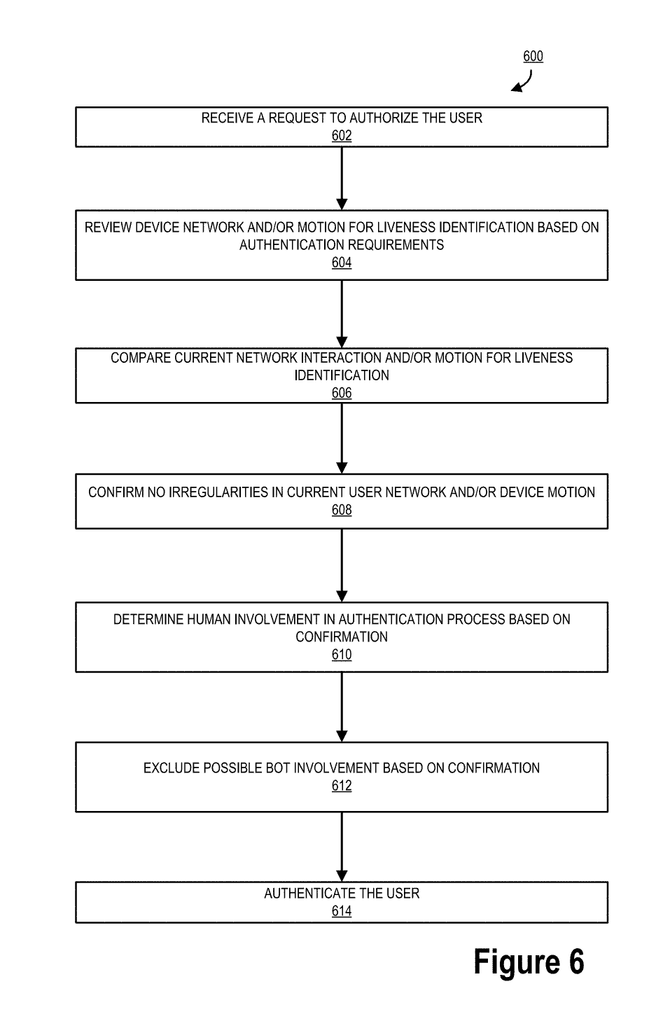

FIG. 6 illustrates a flowchart process of one embodiment of the bot detection and denial system 600, in accordance with embodiments of the present invention. As illustrated in block 602, the process 600 is initiated by receiving a request to authorize the user. In some embodiments, this authorization or authentication is an electronic authorization or authentication. In some embodiments, it may be generated from a device associated with a user. In other embodiments, it may be generated from a bot or via misappropriated application.

As illustrated in block 604, the process 600 continues by reviewing device network and/or motion history for liveness identification based on authentication requirements. In this way, once the linkage has been generated between the system and the device, the system may continue the set up by identifying motion of the user device and the physical activity associated therewith. In this way, the system may learn the regular physical motions of the device, such as the speed the device moves, directions the device moves, times the device is still, times the device is moving, and the like. In some embodiments, the system may learn the regularities of the user device with respect to physical movement. Based on the identified user device motion and physical activity, the system may generate a baseline activity functionality of the user device for future bot detection.

Next, as illustrated in block 606, the process 600 continues by comparing the current network interaction and/or motion to history for liveness identification. In some embodiments, the system reviews user network interaction. In this way, the system may receive an authorization request with a name associated with the request. The system may reviewing networks to determine if the user is a human. Upon indication of user network activity, the system may determine that the user is a human requesting authorization. In some embodiments, the system may monitor the motion of the user device for irregularities. As such, if the user device has not moved for a long period of time and/or is moving at a high rate of speed, the system may identify a bot associated with the authentication request.

As illustrated in block 608, the process 600 continues by confirming that there is no current irregularities in the user network in and/or device motion. In this way, based on the identification of no irregularities in the current user network or device motion the system may identify one or more motions that are specifically human in nature and not that of a bot.

As illustrated in block 610, the process 600 continues by determining human involvement in the authentication process based on the confirmation of network activity for the user or device motion regularities. Based on the confirmation, the system excludes possible bot involvement based on the device movement associated with the liveness, as illustrated in block 612. Finally, as illustrated in block 614, the process 600 is finalized by allowing for authentication of the user for the electronic authentication or authorization requested.

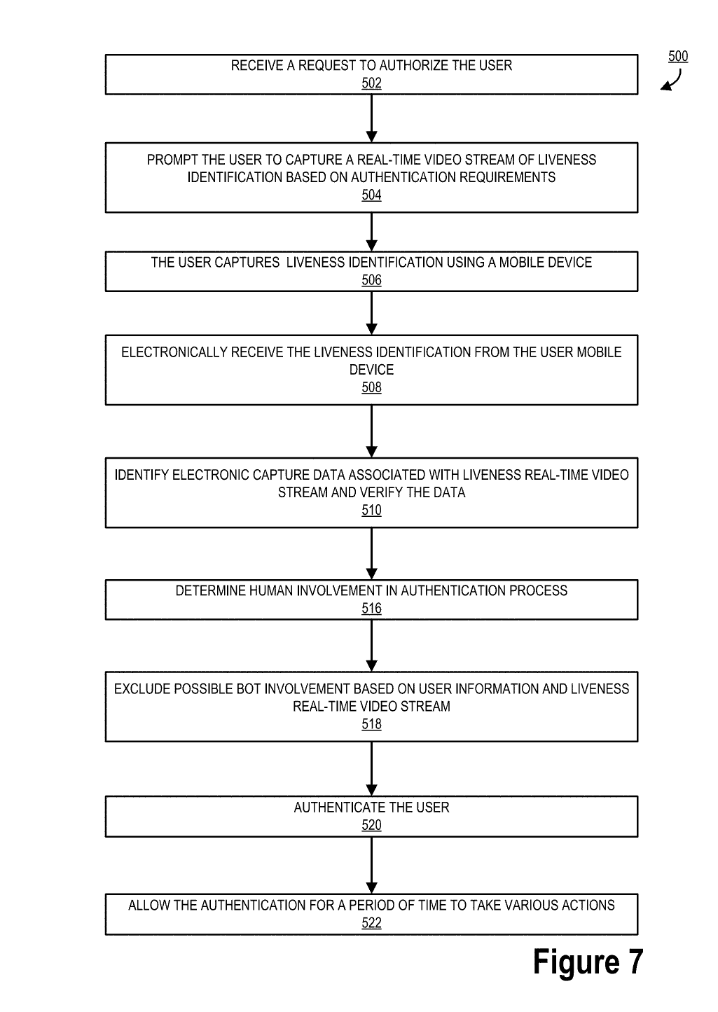

FIG. 7 illustrates one embodiment of the bot detection and denial system process, 500, in accordance with embodiments of the invention. As illustrated in block 502 of FIG. 7 a request is received for authenticating the user. The request may be sent by the user through the user application using the user device and received by the application associated with the authentication system (in some embodiments the request may be sent or received through one or more third-party systems). Block 504 of FIG. 7 illustrates that the authentication requirements are presented to the user. For example, the authentication system may provide authentication requirements to the user through the user application on the user device. The authentication requirements may include information regarding the requirements for the verified identification and/or the liveness identification, as well as other required information needed for authentication. For example, the authentication requirements may include a verified identification requirement, such as the type of verified identification (e.g., driver's license, military identification, business identification, or other like verified identification type), the issue date of the verified identification falling within a specific time frame, the verified identification has not expired, the verified identification includes a photograph of the user, the government entity that issued the verified identification, the location at which the image of the verified identification is captured, the time when the image of the verification identification is captured, or other like verified identification requirement.

Moreover, the authentication requirements may further include liveness identification requirements, such as a type of real-time video stream that may include a side of persons face in the image, location at which the image is captured, time at which the image is captured, length of a video, or the like. Moreover, the authentication requirements may further include an identifier or reference to an identifier to include in the image of the verification identification and/or the liveness identification.

Next, as illustrated in block 506, the process 500 continues by allowing the user to capture the liveness identification using a mobile device, such as the user device. For example, the user may use a video functionality on the user device to stream a real-time video of the user for verifying the user identification. The real-time video stream of the user is electronically received by the application through the authentication systems 10, from the user application, through the user device.

In some embodiments, the user may capture his/her surroundings, self, or the like with the real-time video stream. The stream capture data may include a time stamp indicating the real-time or near real-time at which the video was captured and/or a location at which the stream was captured. The time stamp may be captured using the application that is used to capture the video or another application, and the location data may be captured using an application associated with the location determination component or another application. The stream capture data may be coupled (e.g., embedded within, attached to, referenced by, or the like) to the captured stream and transferred to the authentication system along with the real-time video stream.

FIG. 7 further illustrates in block 508, that the liveness identification stream for the user is received by the system, such as the authentication system at the application from the user device. For example, the liveness identification, in the form of the real-time video stream and data associated with the real-time video stream for the user is electronically received by the application, through the authentication systems, from the user application, through the user device. In some embodiments, the user captures the real-time video stream of the user or user surroundings and the system links to the real-time video stream and directly views the stream as it is occurring. Moreover, as previously discuss, the real-time video stream may include data (e.g., a time stamp, a location, or the like) may also be captured when the user captures the liveness.

Next, as illustrated in block 510, the process 500 continues by identifying the electronic captured data associated with the liveness real-time video stream and verify the data. The user or non-bot may be identified from the verified identification stream, such as by analyzing the stream (e.g., scanning the image for characters, or the like) in order to determine the user is a human. This may be done by visualizing the surroundings of the real-time video stream, identifying the user in the real-time video stream, or the like. The liveness identification may be used to identify that the user that sent and/or is in the verified identification is the same as in the liveness identification image, and that the user in the liveness is active (e.g., alive, the person sending the images, the person requesting authentication, or the like). In some embodiments, further authorization may be used by analyzing the video stream (e.g., by scanning the video, or the like) in order to determine that the user is in the stream (e.g., from facial recognition, or the like). The stream data may also be used to provide additional security to the authentication process. For example, the time and location of the captured of the verified liveness identification image may be captured by the user device and coupled to the images. As such, the organization can identify from the stream the time and location at which each were captured in order to make sure the stream was actually taken by the user and not simply captured from other sources and provided to the organization. Other capture data may also be used such as but not limited to picture quality, pixels, image sizes, or the like. The system may use one or more of these features in order to provide authentication of the user, including using different combinations of features in order to provide different levels of authentication. For example, the system may determine that the user is a human and not a bot.

As illustrated in block 516, the process 500 continues by determining that there is human involvement in the authorization process. In this way, the system identifies that a user human is involved in activating and creating the real-time video stream. This is done by identifying the user in the real-time video stream, identifying surroundings associated with the user in the real-time video stream, or the like. In this way, the video stream, while being able to also provide authentication for the user, indicates that an electronic authorization being performed is not a bot attempting to perform the authentication. As illustrated in block 518, the process 500 continues by excluding the possible bot involvement in the authentication process. Finally, as illustrated in block 520, the system may authenticate the user as a non-bot and allow the authentication for a period of time for the user to take various actions, as illustrated in block 522.

It should be understood, that the systems described herein may be configured to establish a communication link (e.g., electronic link, or the like) with each other in order to accomplish the steps of the processes described herein. The link may be an internal link within the same entity (e.g., within the same financial institution) or a link with the other entity systems. In some embodiments, the one or more systems may be configured for selectively monitoring the resource usage and availability. These feeds of resource usage and availability may be provided via wireless network path portions through the Internet. When the systems are not providing data, transforming data, transmitting the data, and/or creating the reports, the systems need not be transmitting data over the Internet, although it could be. The systems and associated data for each of the systems may be made continuously available, however, continuously available does not necessarily mean that the systems actually continuously generate data, but that a systems are continuously available to perform actions associated with the systems in real-time (i.e., within a few seconds, or the like) of receiving a request for it. In any case, the systems are continuously available to perform actions with respect to the data, in some cases in digitized data in Internet Protocol (IP) packet format. In response to continuously monitoring the real-time data feeds from the various systems, the systems may be configured to update activities associated with the systems, as described herein.

Moreover, it should be understood that the process flows described herein include transforming the data from the different systems (e.g., internally or externally) from the data format of the various systems to a data format associated with the reports for display. There are many ways in which data is converted within the computer environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art in view of this disclosure, embodiments of the invention may be embodied as an apparatus (e.g., a system, computer program product, and/or other device), a method, or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the invention may take the form of a computer program product comprising a computer-usable storage medium having computer-usable program code/computer-readable instructions embodied in the medium (e.g., a non-transitory medium, or the like).

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Python, Smalltalk, C++ or the like. However, the computer program code/computer-readable instructions for carrying out operations of the invention may also be written in conventional procedural programming languages, such as the “C” programming language or similar programming languages.

Embodiments of the invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

### INCORPORATION BY REFERENCE

To supplement the present disclosure, this application further incorporates entirely by reference the following commonly assigned patent applications:

| | U.S. patent | | |
|---|---|---|---|
| | application | | |
| Docket Number | Ser. No. | Title | Filed On |
| 7777US1.014033.3012 | To be assigned | SYSTEM FOR ELECTRONIC | Concurrently |
| | | AUTHENTICATION WITH | herewith |
| | | LIVE USER | |
| | | DETERMINATION | |
| 7779US1.014033.3013 | To be assigned | SYSTEM FOR ALLOWING | Concurrently |
| | | SECURE ACCESS AND USE | herewith |
| | | OF A VIRTUAL | |
| | | CREDENTIAL | |
| 7780US1.014033.3014 | To be assigned | SYSTEM FOR ALLOWING | Concurrently |
| | | SECURE ACCESS AND USE | herewith |
| | | OF A VIRTUAL | |
| | | CREDENTIAL | |

What is claimed is:

1. A system for bot detection and denial during electronic authentication, the system comprising:
one or more memory devices having computer readable code store thereon; and
one or more processing devices operatively coupled to the one or more memory devices, wherein the one or more processing devices are configured to execute the computer readable code to:
receive a request from a user application to provide bot detection for electronic authentications;
access a user device associated with the user application and link, via a communicable linkage into the user device;
identify the user device movements and store the movements as regular movements associated with the user device;
trigger one or more bot detection identifiers upon indication of authorization request processing, wherein the one or more bot detection identifiers includes requiring at least a verified liveness of a user associated with the authorization request processing;
extract and retrieve the verified liveness from the user application via the communicable linkage;
determine liveness of generation of the authorization request processing based on a non-irregularity determination of the one or more bot detection identifiers; and
authorize authentication request as human and not bot generated.

2. The system of claim 1, wherein one or more bot detection identifiers comprise a device movement bot detection identifier, wherein the device movement bot detection further comprises requesting the user to move the user device in a specific pattern or during a time period for confirmation of liveness.

3. The system of claim 1, wherein one or more bot detection identifiers comprise a device motion irregularity bot detection identifier, wherein the device motion irregularity bot detection identifier further comprises comparing the regular movements associated with the user device with movements at the time of the authorization request and a period of time before the authorization request to identify a regularity in the movements associated with the user device for confirmation of liveness.

4. The system of claim 1, wherein one or more bot detection identifiers comprise a network interaction bot detection identifier, wherein the network interaction bot detection identifier further comprises identifying a name associated with the authorization request and comparing the name to network interactions under that name for confirmation of liveness.

5. The system of claim 1, wherein one or more bot detection identifiers comprise a real-time video stream bot detection identifier, wherein the real-time video stream bot detection identifier further comprises requesting the user to generate a real-time video stream of the user or user surroundings for confirmation of liveness.

6. The system of claim 1, further comprising denying the authorization request based on irregularities determined from one or more of the one or more bot detection identifiers.

7. The system of claim 1, wherein liveness further comprises human activity or human generation of the authorization request processing, wherein liveness is not a generation of authorization request processing by software.

8. A computer program product for bot detection and denial during electronic authentication, comprising at least one non-transitory computer-readable medium having computer-readable program code portions embodied therein, the computer-readable program code portions comprising:
an executable portion configured for receiving a request from a user application to provide bot detection for electronic authentications;
an executable portion configured for accessing a user device associated with the user application and link, via a communicable linkage into the user device;
an executable portion configured for identifying the user device movements and store the movements as regular movements associated with the user device;
an executable portion configured for triggering one or more bot detection identifiers upon indication of authorization request processing, wherein the one or more bot detection identifiers includes requiring at least a verified liveness of a user associated with the authorization request processing;
an executable portion configured for extracting and retrieving the verified liveness from the user application via the communicable linkage;
an executable portion configured for determining liveness of generation of the authorization request processing based on a non irregularity determination of the one or more bot detection identifiers; and
an executable portion configured for authorizing authentication request as human and not bot generated.

9. The computer program product of claim 8, wherein one or more bot detection identifiers comprise a device movement bot detection identifier, wherein the device movement bot detection further comprises requesting the user to move the user device in a specific pattern or during a time period for confirmation of liveness.

10. The computer program product of claim 8, wherein one or more bot detection identifiers comprise a device motion irregularity bot detection identifier, wherein the device motion irregularity bot detection identifier further comprises comparing the regular movements associated with the user device with movements at the time of the authorization request and a period of time before the authorization request to identify a regularity in the movements associated with the user device for confirmation of liveness.

11. The computer program product of claim 8, wherein one or more bot detection identifiers comprise a network interaction bot detection identifier, wherein the network interaction bot detection identifier further comprises identifying a name associated with the authorization request and comparing the name to network interactions under that name for confirmation of liveness.

12. The computer program product of claim 8, wherein one or more bot detection identifiers comprise a real-time video stream bot detection identifier, wherein the real-time video stream bot detection identifier further comprises requesting the user to generate a real-time video stream of the user or user surroundings for confirmation of liveness.

13. The computer program product of claim 8, further comprising an executable portion configured for denying the authorization request based on irregularities determined from one or more of the one or more bot detection identifiers.

14. The computer program product of claim 8, wherein liveness further comprises human activity or human generation of the authorization request processing, wherein liveness is not a generation of authorization request processing by software.

15. A computer-implemented method for bot detection and denial during electronic authentication, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving a request from a user application to provide bot detection for electronic authentications;
accessing a user device associated with the user application and link, via a communicable linkage into the user device;
identifying the user device movements and store the movements as regular movements associated with the user device;
triggering one or more bot detection identifiers upon indication of authorization request processing, wherein the one or more bot detection identifiers includes requiring at least a verified liveness of a user associated with the authorization request processing;
extracting and retrieving the verified liveness from the user application via the communicable linkage;
determining liveness of generation of the authorization request processing based on a non-irregularity determination of the one or more bot detection identifiers; and
authorizing authentication request as human and not bot generated.

16. The computer-implemented method of claim 15, wherein one or more bot detection identifiers comprise a device movement bot detection identifier, wherein the device movement bot detection further comprises requesting the user to move the user device in a specific pattern or during a time period for confirmation of liveness.

17. The computer-implemented method of claim 15, wherein one or more bot detection identifiers comprise a device motion irregularity bot detection identifier, wherein the device motion irregularity bot detection identifier further comprises comparing the regular movements associated with the user device with movements at the time of the authorization request and a period of time before the authorization request to identify a regularity in the movements associated with the user device for confirmation of liveness.

18. The computer-implemented method of claim 15, wherein one or more bot detection identifiers comprise a network interaction bot detection identifier, wherein the network interaction bot detection identifier further comprises identifying a name associated with the authorization request and comparing the name to network interactions under that name for confirmation of liveness.

19. The computer-implemented method of claim 15, wherein one or more bot detection identifiers comprise a real-time video stream bot detection identifier, wherein the real-time video stream bot detection identifier further comprises requesting the user to generate a real-time video stream of the user or user surroundings for confirmation of liveness.

20. The computer-implemented method of claim 15, further comprising denying the authorization request based on irregularities determined from one or more of the one or more bot detection identifiers.
